(19) United States
(12) Patent Application Publication
(10) Pub. No.: US 2007/0099525 A1
(43) Pub. Date: May 3, 2007

(54) Fireproof cover for spring mattresses

(76) Inventor: Paolo Barberis Canonico, Batley West Yorkshire (GB)

Correspondence Address: BACON & THOMAS, PLLC, 625 SLATERS LANE, FOURTH FLOOR, ALEXANDRIA, VA, 22314, US

(21) Appl. No.: 11/260,221

(22) Filed: Oct. 28, 2005

(51) Int. Cl. B32B 5/02; B32B 9/00

(52) U.S. Cl. 442/59; 5/690

(57) ABSTRACT

A fireproof cover for spring mattresses made of a fireproof non-woven fabric comprising about 100% of cellulose fibers, said fibers being stitchbonded with synthetic yarns and impregnated with a phosphorus and nitrogen salts base fireproof agent, said fireproof cover for spring mattresses being intended to comply with TB 603 regulations, release of July 2003, issued by the State of California, U.S.A., said cover comprising a first internal layer of said non-woven fabric impregnated with said fireproof agent having a concentration of about 280 g/l, that is equivalent to an amount of such fireproof agent, as dry product, of about 16.8 g for 1 m² of said first layer of fireproof non-woven fabric, and a second external layer of said non-woven fabric impregnated with said fireproof agent having a concentration variable between 280 g/l and 380 g/l, that is equivalent to an amount of such fireproof agent, as dry product, varying between 16.8 g and 22.8 g for 1 m² of said second layer of fireproof non-woven fabric.

### FIELD OF THE INVENTION

The invention concerns a fireproof cover for spring mattresses and, in particular, a fireproof cover obtained with a fireproof non-woven fabric containing cellulose fibers.

More precisely, the invention concerns a fireproof non-woven fabric cover for spring mattresses intended to comply with TB 603 (Technical Bulletin 603) regulations, release of July 2003, issued by the Bureau of Home Furnishings and Thermal Insulation of the Department of Consumer Affairs of the State of California, U.S.A.; the aforesaid regulations, entitled “Requirements and Test Procedure for Resistance of a Residential Mattress/Box Spring Set to a Large Open-Flame”, has been issued to quantify and regulate the flammability resistance performance of mattresses in an attempt to reduce the number of deaths due to fires breaking out inside private houses, hotels and institutional facilities such as hospitals and rest homes. The reference TB 603 regulations specifies that a barrier fitted to prevent the fire propagation to the whole mattress must be realized.

### DESCRIPTION OF THE PRIOR ART

On Jun. 2, 2005, the same inventor hereof filed before the U.S. Patent and Trademark Office the patent application Ser. No. 11/142,270 entitled “Fireproof non-woven fabric, method of manufacturing thereof and mattress cover obtained thereby” relating to a new fireproof non-woven fabric suitable for manufacturing fireproof mattress covers, said new fireproof non-woven fabric comprising cellulose fibers, optionally synthetic fibers and stitchbonding synthetic yarns impregnated with a fireproof agent containing phosphorus and nitrogen salts.

Said fireproof non-woven fabric used as mattress cover proved to be in compliance with the above-mentioned TB 603 regulations, release of July 2003, as reported in detail in the U.S. patent application Ser. No. 11/142,270 cited hereinbefore; it is to be noticed that the mattress used for the experimental tests carried out and reported in said U.S. patent application Ser. No. 11/142,270 included a stuffing made of a flexible foam material.

Recent experimental tests carried out by the inventor have shown that spring mattresses covered with said fireproof non-woven fabric, formed as a single layer fabric, are sometimes not able to satisfactorily meet the requirements of the above-mentioned TB 603 regulations, release of July 2003.

### SUMMARY OF THE INVENTION

The object of the present invention is therefore to overcome the above-mentioned limitation of the previous solution attained by the same inventor, so obtaining successful results in terms of fireproof properties complying with TB 603 regulations, release of July 2003, for spring mattresses.

This and other objects are achieved with the fireproof non-woven fabric cover for spring mattresses as claimed in the appended claims.

Advantageously, the fireproof non-woven fabric cover, formed by two layers of said non-woven fabric, according to the invention allows to obtain successful results in terms of fireproof properties complying with TB 603 regulations, release of July 2003, for spring mattresses.

Further features and advantages will become evident from the description of a preferred embodiment of the present invention, which will be now disclosed in detail with reference to case samples and also with reference to the attached figure, given by way of non limiting example.

### BRIEF DESCRIPTION OF THE FIGURE

FIG. 1 schematically shows a cross section of a spring mattress covered with the fireproof non-woven fabric cover according to the present invention.

### DESCRIPTION OF THE INVENTION

The invention substantially resides in the use as a cover for spring mattresses of a non-woven fabric comprising about 100% of cellulose fibers, traces only of non-cellulose fibers such as for example synthetic fibers being allowed, said fibers being stitchbonded with synthetic yarns and said non-woven fabric being subjected to fireproofing treatment by impregnation with a fireproof agent, preferably a fireproof agent containing phosphorus and nitrogen salts.

As anticipated, by testing on spring mattresses the fireproof non-woven fabric cover according to the invention disclosed in the above-mentioned patent application no. 11/142,270, it has been found out that said cover was sometimes not able to satisfactorily meet the requirements of TB 603 regulations, release of July 2003, due to the fact that an amount of total heat developed in the first 10 minutes much higher than the maximum acceptable value of 25 MJ was developed.

Said total heat developed in excess has been related to the presence of air entrapped inside spring mattresses, which are hollow bodies, said air forming an extra combustive agent contributing to heat generation.

Furthermore, even a very low content of synthetic fibers, such as that provided in the cover according to the above-mentioned patent application no. 11/142,270, can adversely impact on the fireproof properties of the cover because these synthetic fibers have the drawback, by burning, to shrink and to leave “holes” in the material, so allowing fire to propagate inside the mattress where it is even more fostered by the presence of air entrapped inside springs, as aforesaid.

As it is not possible to avoid the presence of air inside spring mattresses, it has been found that a satisfactory performance in terms of fireproof properties can be attained by maintaining air isolate with respect to the outside.

Therefore, according to the present invention, two layers of fireproof non-woven fabric are provided to form the cover for spring mattresses, a first internal layer and a second external layer, said first internal layer acting mainly as an isolating cover and said second external layer acting as the very fireproof cover.

Said first internal layer, preferably not decorated i.e. made of the raw fireproof non-woven fabric, has a final weight preferably of about 140 g/m², said weight also comprising the weight of the dry product of the fireproof agent laid down onto the non-woven fabric surface.

Said second external layer, preferably decorated, has a final weight preferably variable between 140 and 190 g/m², more preferably variable between 145 and 190 g/m², said weight also comprising both the weights of the dry product of the fireproof agent laid down onto the non-woven fabric surface and of the dry color laid down onto the decorated non-woven fabric surface.

As far as the composition of the non-woven fabric and its method of manufacturing are concerned, reference is made to the cited patent application Ser. No. 11/142,270.

According to the present invention, it is preferred that the non-woven fabric is completely made of cellulose fibers, preferably viscose fibers, with at most traces only of synthetic fibers.

In the preferred embodiment according to the present invention, the non-woven fabric is formed by about 50% by weight of viscose flock and by about 50% by weight of frayed viscose.

The percent values mentioned above are calculated on the basis of the pure fibers blend and are therefore exclusive of the amount of synthetic yarns (yarn count preferably of 78/36 dtex; stitchbonding preferably of 1.6 mm) used for stitchbonding, which synthetic yarns form about from 9% to 15% by weight of the fireproof non-woven fabric as final product, i.e. already impregnated with the fireproof agent.

At loom, the raw non-woven fabric preferably has a weight of about 150 g/m², in order to reach a weight preferably of about 130 g/m² after thermosetting but before printing and carrying out the fireproof treatment.

The raw non-woven fabric preferably has a width of about 370 cm, in order to reach a final width preferably of about (210+210) cm.

According to the present invention, the thermosetting step is carried out at a thermosetting temperature preferably of about 170° C. and at a thermosetting rate preferably of about 60 m/min on a tentering machine, which is a well known equipment in the textile field.

As far as the fireproof agent used to impregnate the non-woven fabric is concerned, reference is made to the cited patent application no. 11/142,270.

In the preferred embodiment according to the present invention, the commercial chemical compound named “APYROL DP” and manufactured by CHT R. BEITLICH GmbH-DE is used as fireproof agent; this fireproof agent contains phosphorus and nitrogen salts, said salts being responsible of the flame propagation blocking action.

It has been found out that for the use according to the present invention the following concentrations of the “APYROL DP” agent in the foulard vats are needed:
for the first not decorated internal layer, a concentration of preferably about 280 g/l, that is equivalent to an amount of such fireproof agent, as dry product, of about 16.8 g for 1 m² of said first layer of fireproof non-woven fabric; and
for the second decorated external layer, a concentration preferably variable between 280 g/l and 380 g/l, that is equivalent to an amount of such fireproof agent, as dry product, varying between 16.8 g and 22.8 g of said second layer of fireproof non-woven fabric.

After having carried out the fireproof treatment of the non-woven fabric by impregnation with the fireproof agent as specified hereinabove, the drying step of the non-woven fabric become fireproof occurs, the tentering machine being preferably set at the following operating conditions: rate of about 38 m/min, temperatures in the range 140-155° C. and pressure of about 2.3 10² kPa (2.3 bar).

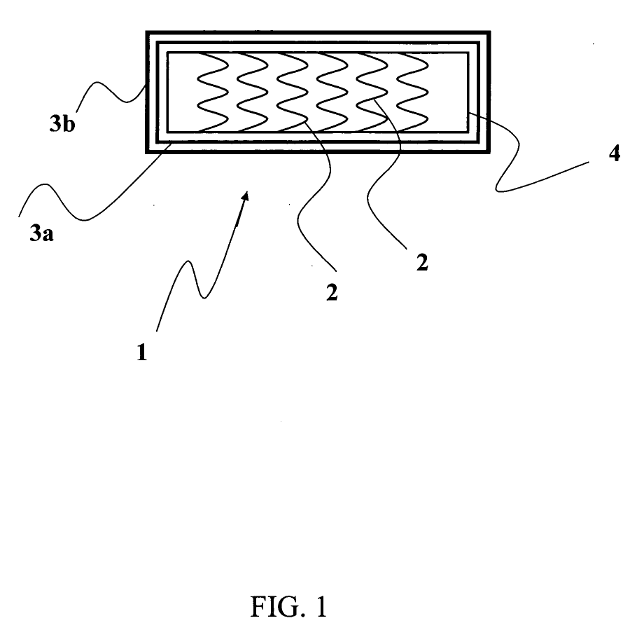

In relation to the use of the fireproof non-woven fabric according to the present invention as mattress cover for spring mattresses and with reference to FIG. 1, which schematically shows a cross section of a spring mattress covered with two layers of said fireproof non-woven fabric, it can be seen that mattress 1 is formed by a plurality of springs 2 made of metal, preferably steel; said springs are held in position and protected by means of holding and filling material 4 preferably made of felt weighing about 900 g/m² and having a thickness of about 5 mm.

Always with reference to FIG. 1, it can be seen that the mattress cover consists of a first internal layer 3a and of a second external layer 3b, both made of the fireproof non-woven fabric according to the present invention as described in detail hereinbefore and having a thickness variable between 0.5 and 1 mm, preferably 0.6 mm.

Since the manufacturing for covering a spring mattress by using the fireproof non-woven fabric according to the present invention employs technologies and equipment known to the person skilled in the art, said technologies and equipment will not be described in detail.

In order to verify the compliance to the requirements of TB 603 regulations, release of July 2003, experimental tests have been carried out at a certified Laboratory; in particular, it has been seen that for layers of the non-woven fabric according to the invention having a composition containing 100% of viscose and being impregnated with “APYROL DP” phosphorus and nitrogen salts base fireproof agent, a fire resistance higher than the thresholds imposed by the aforesaid regulations is obtained.

As far as more in detail the experimental tests are concerned, they have been carried out according to the procedures prescribed by TB 603 regulations, release of July 2003, by using test samples made as follows.

In order to obtain 1 m² of internal layer made of raw fireproof non-woven fabric, whose weight is about 140 g/m², the indicated amounts are needed:

| | |
|---|---|
| viscose fibers | 108 g, |
| polyester yarns | 15 g, |
| fireproof agent | 17 g. |

In order to obtain 1 m² of external layer made of raw fireproof non-woven fabric, whose weight is about 145 g/m², the indicated amounts are needed:

| | |
|---|---|
| viscose fibers | 106 g, |
| polyester yarns | 15 g, |
| fireproof agent | 17 g. |

In order to obtain 1 m² of external layer made of raw fireproof non-woven fabric, whose weight is about 190 g/m², the indicated amounts are needed:

| | |
|---|---|
| viscose fibers | 145 g, |
| polyester yarns | 15 g, |
| fireproof agent | 23 g. |

For the above external layers, which are decorated, the following amount due to the colors used has to be added to the previous amounts:

| | |
|---|---|
| color | 6 g. |

The first sample, that is the raw fireproof non-woven fabric, has been used to produce the first internal layer of the spring mattress cover to be tested, said layer having a thickness of 0.6 mm and a weight of 140 g/m².

The second and third samples, that is the decorated fireproof non-woven fabrics, have been used to produce the second external layer of the spring mattress cover to be tested, said layers having respectively a weight of 145 g/m² and 190 g/m².

A felt filling has been used having a thickness of 5 mm and a weight of 900 g/m².

More precisely, two different spring mattress have been tested:
the first tested spring mattress was formed by a plurality of metal springs, felt as spring protection having a weight of 900 g/m², covered by a first layer of raw fireproof non-woven fabric made of 100% of viscose and having a weight of 140 g/m² and by a second layer of decorated fireproof non-woven fabric made of 100% of viscose and having a weight of 145 g/m²;
the second tested spring mattress was formed by a plurality of metal springs, felt as spring protection having a weight of 900 g/m², covered by a first layer of raw fireproof non-woven fabric made of 100% of viscose and having a weight of 140 g/m² and by a second layer of decorated fireproof non-woven fabric made of 100% of viscose and having a weight of 190 g/m².

The tests have been carried out on the spring mattress models as described above, wherein each mattress rest surface is identical to the opposite one and the composition of the mattress sides is the same as the rest surfaces.

All the materials have been conditioned as requested by TB 603 regulations, release of July 2003, before preparing the sample.

The tests have been carried out as requested by the above-mentioned regulations.

The results evaluation procedure has been carried out by comparing with the values reported in the above-mentioned TB 603 regulations, release of July 2003, set out in the following tables:

Spring mattress model with the external layer having a weight of 145 g/m²

| | | REQUESTED VALUE BY TB |
|---|---|---|
| | | 603 |
| PARAMETER | FOUND VALUE | (release of July 2003) |
| Heat release | <3 | <200 |
| maximum (peak) | | |
| rate [kW] | | |
| Total heat | <1 | <25 |
| developed in the | | |
| first 10 min. | | |
| [MJ] | | |

Spring mattress model with the external layer having a weight of 190 g/m²

| | | REQUESTED VALUE BY TB |
|---|---|---|
| | | 603 |
| PARAMETER | FOUND VALUE | (release of July 2003) |
| Heat release | 10 | <200 |
| maximum (peak) | | |
| rate [kW] | | |
| Total heat | 0.8 | <25 |
| developed in the | | |
| first 10 min. | | |
| [MJ] | | |

It is to be noticed that the heat release maximum (peak) rate, expressed in [kW], and the total heat developed in the first 10 min., expressed in [MJ], are exclusive of the burners contribution.

As it is seen, the obtained results have been extremely satisfying, given that the tested material fire resistance resulted by far higher than that requested by TB 603 regulations, release of July 2003.

The experimental tests carried out have therefore proved that the two layers fireproof non-woven fabric cover for spring mattresses according to the present invention satisfactorily complies with TB 603 regulations, release of July 2003.

Though the invention has been illustrated with reference to a preferred embodiment, it is in general susceptible of other applications and modifications that are meant to be comprised within the protective scope.

In particular, the use of the two layers fireproof non-woven fabric cover according to the invention as spring mattresses cover has been illustrated, but it could be as much as usefully employed for covering furniture, such as for instance armchairs and sofas, which are usually also provided with springs, as it will be evident to the person skilled in the art.

1. A fireproof cover for spring mattresses made of a fireproof non-woven fabric comprising about 100% of cellulose fibers, said fibers being stitchbonded with synthetic yarns and impregnated with a phosphorus and nitrogen salts base fireproof agent, said cover comprising:
a first internal layer of said non-woven fabric impregnated with said fireproof agent having a concentration of about 280 g/l, that is equivalent to an amount of such fireproof agent, as dry product, of about 16.8 g for 1 m² of said first layer of fireproof non-woven fabric; and
a second external layer of said non-woven fabric impregnated with said fireproof agent having a concentration variable between 280 g/l and 380 g/l that is equivalent to an amount of such fireproof agent, as dry product, varying between 16.8 g and 22.8 g for 1 m² of said second layer of fireproof non-woven fabric.

2. The fireproof cover for spring mattresses according to claim 1, wherein said mattress cover has fireproof properties such as to comply with TB 603 regulations, release of July 2003, issued by the State of California, U.S.A., namely, being characterized by a heat release maximum (peak) rate lower than 200 kW and by an amount of total heat developed in the first 10 minutes lower than 25 MJ.

3. The fireproof cover for spring mattresses according to claim 1, wherein said first internal layer is raw and has a final weight of about 140 g/m², said weight also comprising the weight of the dry product of the fireproof agent laid down onto the non-woven fabric surface.

4. The fireproof cover for spring mattresses according to claim 1, wherein said second external layer is decorated and has a final weight variable between 140 and 190 g/m², preferably variable between 145 and 190 g/m², said weight also comprising both the weights of the dry product of the fireproof agent laid down onto the non-woven fabric surface and of the dry color laid down onto the decorated non-woven fabric surface.

5. The fireproof cover for spring mattresses according to claim 1, wherein said fireproof non-woven fabric has the following composition: about 50% by weight of viscose flock and about 50% by weight of frayed viscose.

6. The spring mattress comprising a plurality of springs, a filling material and a fireproof cover according to claim 1.

7. The spring mattress according to claim 6, wherein said cover has fireproof properties such as to comply with TB 603 regulations, release of July 2003, issued by the State of California, U.S.A., namely, being characterized by a heat release maximum (peak) rate lower than 200 kW and by an amount of total heat developed in the first 10 minutes lower than 25 MJ.
